(19) United States
(12) Patent Application Publication
(10) Pub. No.: US 2019/0191720 A1
(43) Pub. Date: Jun. 27, 2019

(54) DOUGH PROCESSING MACHINE

(71) Applicant: Henri BAISSAS, Saint Cyprien Plage (FR)

(72) Inventor: Henri BAISSAS, Saint Cyprien Plage (FR)

(21) Appl. No.: 16/501,164

(22) PCT Filed: Jul. 20, 2017
(86) PCT No.: PCT/FR2017/000145

§ 371 Date: Feb. 27, 2019

(30) Foreign Application Priority Data
Jul. 22, 2016 (FR) 16/56994

(51) Int. Cl. A21C 9/08; A21C 5/00; B26D 7/06; B26D 7/32; B26D 1/43

(52) U.S. Cl. CPC A21C 9/085; A21C 5/00; B26D 1/43; B26D 7/32; B26D 7/0625

(57) ABSTRACT

The invention concerns a special processing machine for dough, comprising—a cutting conveyor (3), a cutting blade (5) for cutting in a cutting direction (6), the blade (5) and/or the cutting conveyor being further driven in translation for separation purposes such that the blade (5) moves in translation relative to and along the cutting band while remaining substantially in contact with the latter, characterised by—a receiving conveyor (7) comprising a longitudinal receiving band (8), and in which the cutting conveyor (3) driven by the blade (5) is movable between an entry position and a transfer position, the blade and/or the cutting conveyor (3) further being driven in translation for transfer purposes such that the blade (5) then comes into contact with the receiving band (8).

### TECHNICAL FIELD

The present invention relates to a dough processing machine, particularly in the fields of bakery/viennoiseries or pastry.

### BACKGROUND

In these fields, the dough generally used has a content of about 60% by weight relative to the weight of flour of the dough. The usual materials and processes are adapted to this type of dough. Beyond this water content, the dough acquires special mechanical properties and becomes sticky and more difficult to process, especially to cut to distribute in cooking media.

One solution proposed in the prior art relates to sprinkling some flour on the dough and/or using a cutting blade to improve the treatment thereof. However, this type of solution is difficult to apply at an industrial scale.

In addition, hyper hydrated dough has such elasticity that after cutting it with a blade, when the blade is removed, the dough is reformed.

An object of the present invention is to provide a machine and a process for treating highly hydrated dough, better adapted to industrial use, namely enabling in particular to cut and distribute it for baking dough pieces.

### SUMMARY

To achieve this objective, the invention concerns a processing machine, in particular for dough, the machine comprising
a cutting conveyor comprising a longitudinal cutting band,
a blade configured to be driven in a cutting movement according to a cutting direction that is non-parallel to the cutting band so as to come into contact with the cutting and, the blade and/or the cutting conveyor are further configured to be driven in a separating translation so that the blade translates relative to and along the cutting band while remaining substantially in contact with the cutting band.

According to the invention, the machine comprises a receiving conveyor comprising a longitudinal receiving band, the cutting conveyor being able to be arranged at least partially above the receiving conveyor, and furthermore, the cutting conveyor is movable between
an entry position in which the cutting conveyor extends longitudinally in an entry direction which is not parallel to the cutting direction, and
a transfer position in which the cutting conveyor extends in a direction of transfer different from the entry direction, and the cutting band comes into contact with the receiving band, the cutting conveyor being configured to be driven by the cutting blade, from the entry position to the transfer position, the blade and/or the cutting conveyor are further configured to be driven in a transfer translation so that the blade translates relative to and along the cutting band at one end thereof while remaining substantially in contact with said end, then the blade comes into contact with the receiving band.

Advantageously, the machine according to the invention is configured so that after the blade has cut the dough, the blade and/or the cutting support driven in translation can easily transfer dough on the receiving conveyor. In addition, the blade being in contact with the cutting band and the receiving band during the cutting, allows efficient cutting of hyper hydrated dough, despite the fact that such dough is very sticky.

According to other aspects taken individually or combined in any technically implementable combination:
the blade is driven in the separating translation, and the conveyor is driven in the transfer translation; and/or
the cutting conveyor is further movable from a rest position in which the cutting conveyor is away from the blade, to the entry position, and preferably from the transfer position to the rest position ; and/or
the cutting conveyor is mobile and rotatable between the entry position and the transfer position; and/or
the blade is further configured to be driven in translation in a slicing direction perpendicular to the separating translation; and/or
the machine further comprises a cooking device associated with the receiving conveyor; and/or
the receiving conveyor is arranged between the cutting conveyor and the cooking device; and/or
at least one working surface, preferably the receiving band, comprises a non-stick coating; and/or
The cutting conveyor has a section of a triangular type in the conveying direction.

The invention also relates to a process for treating dough comprising more than 80% by weight of water relative to the weight of flour of the dough, the process comprising the use of a treatment machine according to one of the preceding claims.

More generally, the invention relates to a process of treatment, in particular for a dough, the process comprising steps for
driving a longitudinal cutting band of a cutting conveyor,
driving a blade in a cutting motion in a cutting direction not parallel to the cutting band so as to come into contact with the cutting band,
driving the blade and/or the cutting conveyor in a separating translation such that the blade translates relatively to and along the cutting band while remaining substantially in contact with the cutting band,
preferably arranging the cutting conveyor at least partially Above the receiving conveyor,
driving the cutting conveyor, through the blade in cutting motion,
from an entry position in which the cutting conveyor extends longitudinally in an entry direction which is not parallel to the cutting direction, towards
a transfer position in which the cutting conveyor extends in a direction transfer direction different from the direction of entry, and the cutting band comes into contact with the receiving band,
driving the blade and/or the cutting conveyor in transfer translation so that the blade translates relatively to and along the cutting band at one end thereof while remaining substantially in contact with said end, and then the blade comes into contact with the receiving band.

### BRIEF DESCRIPTION OF THE DRAWINGS

The invention will be further described by the description of non-limiting embodiments, and on the basis of the appended figures, in which:

FIG. 1 side view of the machine according to a preferred embodiment of the invention;

FIGS. 2 to 5 are side views according to FIG. 1 illustrating successive steps processing by said machine, before returning to the state of FIG. 1; and

FIG. 6 top view of the machine of FIG. 1.

### DETAILED DESCRIPTION

The invention relates to a processing machine in particular for dough 1, 2, such as a highly hydrated bread dough. This type of dough generally comprises more than 60% by weight of water relative to the weight of flour of the dough.

The machine comprises a cutting conveyor 3 comprising a longitudinal cutting band 4. Conveyor band drive systems may include a drive wheel and a motor. According to one variant, the cutting conveyor 3 has a section of triangular type in the conveying direction. More generally, the cutting conveyor 3 comprises a thin portion. For example, the cutting band has, for this purpose, an elevation of twenty centimeters every three meters.

Advantageously, a conveyor band allows easy movement of the dough 1, 2. In addition, a conveyor band may be oriented in an oblique direction. An oblique direction makes it possible to use gravity for conveying and/or transferring when the conveyor band is sloping.

On the cutting band 4 is disposed a dough to be cut. In particular, the dough to be cut is in the form of a dough band 1 having a band length in a conveying direction defining the progression of the dough band 1, and a band width perpendicular to the conveying direction.

The dough band 1 is formed for example by successive demoldings of several pieces of dough on the cutting conveyor 3 along the length of the cutting band 4. The dough pieces then stick together because of the specific properties of elasticity and gluing of the hyper hydrated dough.

According to a variant, the machine further comprises a raising support (not shown), on which the dough rises before being transferred onto the conveying support. For example, a raising tray may be provided for this purpose.

Preferably, the cutting conveyor 3 is configured to receive the dough band 1 on a constant dimension in a direction perpendicular to a cutting direction 6, in particular along the width of the dough band 1. The dough band 1 is cut along its width. Thus, the width of the bandage determines a standard length of dough.

The machine further comprises a blade 5 configured to be driven in a cutting motion in the cutting direction 6. The blade 5 cuts the dough band 1. In particular, the cutting direction 6 is vertical and the blade 5 is driven downwardly. Preferably, the cutting movement is a translation.

Cutting in translation, also called guillotining, allows a regular cutting of the dough. A rotating cutting movement can also be envisaged.

The cutting direction 6 is non-parallel to the cutting band 4. Preferably, these directions are perpendicular to each other to produce straight dough extending perpendicularly to the cutting band 4

During the cutting movement, the blade 5 engages in the dough band 1 so as to delimit it in two parts, namely a residual dough band 1 and dough 2 to be baked for bread.

The settings of the actuating force of the blade 5 can be adapted according to the composition of the dough 1, 2. Preferably, the blade 5 descends very quickly in contact with the dough band 1 and then slows down on contact with it, penetrates the dough at medium speed to cut at full power then goes back to fast speed.

According to one variant, water or flour may be previously spread on the blade 5 and/or on the dough band 1 before cutting, to prevent the dough from sticking to the blade 5. Preferably, the machine is configured to spread flour and/or water on the blade 5 before cutting.

The best results are obtained by spraying, preferably regularly, water into fine droplets on the slide and optionally by pouring flour on the dough. The water makes it possible to have practically no sticky dough on the blade 5.

A nebulization of water on the blade 5 gives excellent results while optimizing the amount of water on the blade. The blade 5 driven in cutting movement comes into contact with the cutting band 4.

The blade 5 and/or the cutting conveyor may also be configured to be driven in translation separation 5a so that the blade 5 translates relative to and along the cutting band 4 while remaining substantially in contact with the band 4. The separation translation is performed on one to two centimeters.

Preferably, the separation translation is carried out so that the blade 5 translates relatively to the cutting band 4 and in particular in the direction of progression of the dough band.

Preferably, the blade 5 is driven according to the separation translation, the cutting conveyor 3 remaining in the transfer position.

According to a variant, the blade 5 is further configured to be driven in translation in a slicing direction perpendicular to the separation translation 5a. With reference to the figures, the slicing direction is perpendicular to the plane of the figures.

A movement in the slicing direction 5b makes it possible to better cut the hyper hydrated dough, despite the mechanical stresses.

For example, the slicing motion is of two centimeters.

According to the invention, the machine further comprises a receiving conveyor 7 comprising a longitudinal receiving band 8. The cutting conveyor 3 may be arranged, at least partially, above the receiving conveyor 7, and the cutting conveyor 3 is movable between an entry position and a transfer position detailed below.

According to one variant, the cutting conveyor 3 is also movable from a rest position in which the cutting conveyor 3 is away from the blade 5 towards the entry position, and preferably from the transfer position towards the rest position. In particular, the cutting conveyor 3 is first in the rest position before being moved to the entry position, in which the blade 5 driven in cutting motion can come into contact with the cutting band.

In the entry position, the cutting conveyor 3 extends longitudinally in a non-parallel direction of entry to the cutting direction.

In the transfer position, the cutting conveyor 3 extends in a direction of transfer different from the direction of entry, and the cutting band 4 comes into contact with the receiving band 8.

According to a variant, the cutting conveyor 3 is rotatable between the entry position and the transfer position.

The cutting conveyor 3 is configured to be driven by the blade in cutting motion from the entry position to the transfer position.

The blade and/or the cutting conveyor 3 are further configured to be driven in transfer translation so that the blade 5 translates relative to and along the cutting band 4 at one end thereof while remaining substantially in contact with said end, then the blade 5 comes into contact with the receiving band. In particular, the blade 5 remains substantially in contact with the cutting band 4 at said end.

Advantageously, the blade in contact with the cutting band 4 and the receiving band during cutting, allows efficient cutting of hyper hydrated dough, despite the fact that such dough is very sticky.

Preferably, the transfer translation is performed so that the blade 5 translates relatively to the cutting band 4 and in particular in a direction opposite to the direction of progression of the dough.

Preferably, the cutting conveyor 3 is driven according to the transfer translation 3a, the blade 5 remaining at the end of the cutting movement.

Thus, the machine is configured so that after cutting, a portion of the dough, namely the dough 2, is transferred to the receiving conveyor 7.

Advantageously, the machine according to the invention is configured so that after the blade has cut the dough, the blade and/or the cutting support driven in translation make it easy to transfer dough 2 on the receiving conveyor 7.

In addition, the machine according to the invention allows automation and industrialization of the treatment to produce larger quantities of cut dough, and preferably cooked.

In a variant, substantially simultaneously with the transfer translation, the cutting band is actuated to put the residual dough band 1 in position for the next cut.

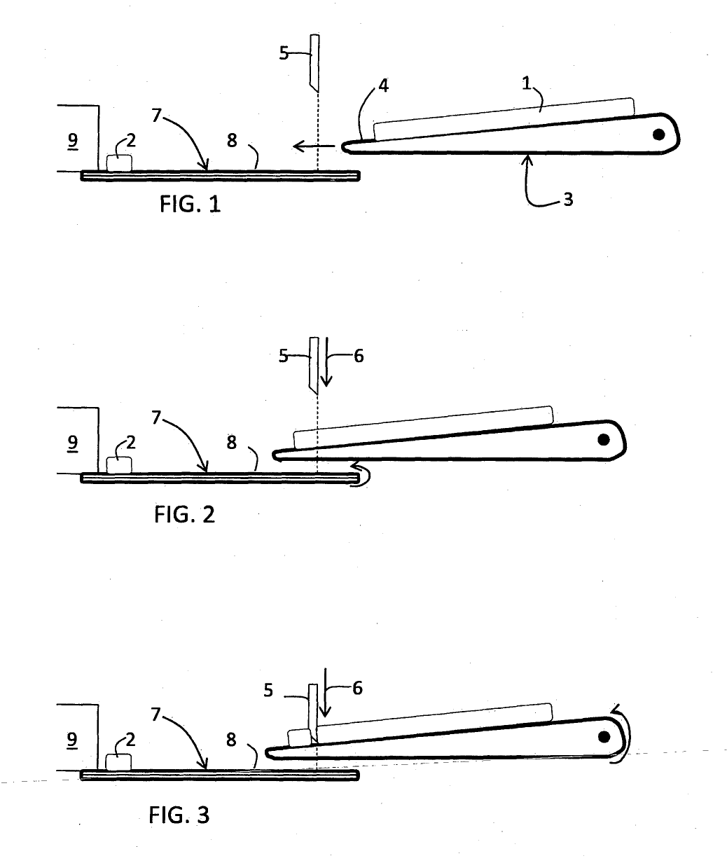

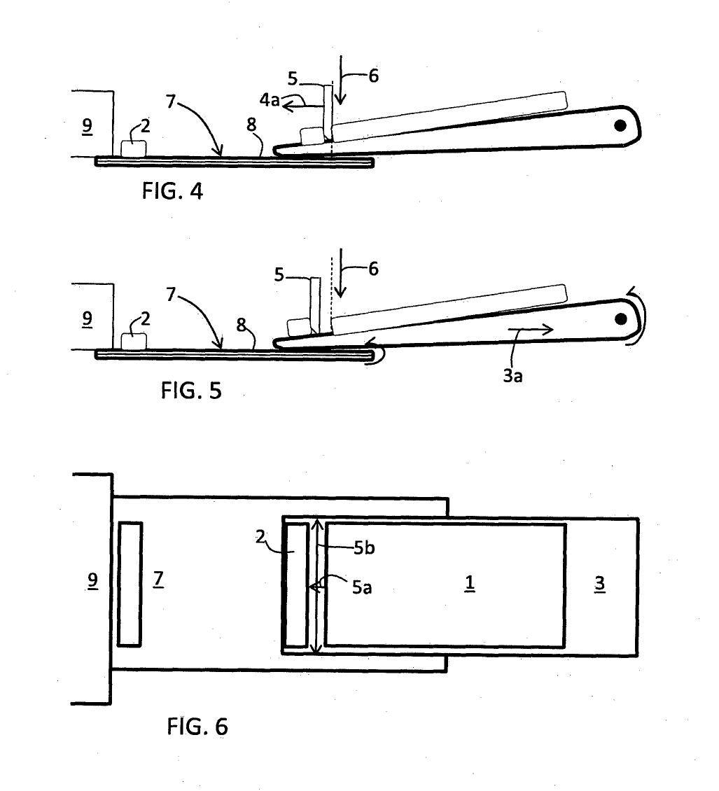

Preferably, after the transfer, the blade 5 and the cutting conveyor are configured to return to their initial positions, in particular that illustrated in FIG. 1. Return means such as springs may be provided for this purpose. Advantageously, such return means allow easy return to the initial position. Cylinders may be provided for returns of the blade 5 and/or the cutting support 5 to their initial positions.

According to a variant, jacks are used to drive the cutting conveyor 3 in the transfer translation, and/or the blade 5 in the cutting and/or separation translation.

According to a variant, at least one working surface, preferably the receiving band 8, comprises a non-stick coating. For example, polytetrafluoroethylene (ptfe) can be used. Advantageously, the treatment of the dough is facilitated because it is less tacky on these surfaces.

Preferably, the receiving band 8 is configured to move the dough in a cooking zone. Advantageously, a receiving band 8 comprising a non-stick coating makes it possible to counteract an increase in the adhesion properties of the dough due to cooking.

According to one variant, the machine further comprises a cooking device 9 associated with the receiving conveyor 7. The cooking device 9, such as an oven, is preferably traversed by the receiving band 8.

According to a variant, the receiving conveyor 7 is disposed between the cutting conveyor 3 and the cooking device 9. Such an arrangement makes it possible to limit the size of the treatment device in the vertical direction.

The invention also relates to a process for treating dough comprising more than 80% by weight of water relative to the weight of flour of the dough, the process comprising the use of a processing machine according to the invention.

Such a process makes it possible to create automated production lines for cooked dough, in particular for bread.

In particular, dough, in particular bread dough, having a content of more than 90% or even 100% to 110% can be treated with the machine according to the invention. Surprisingly, the applicant has found that this type of dough, although difficult to treat with conventional instruments, provides a bread more tasty than the breads of the prior art, at lower cost.

According to a variant, the dough of the processing machine is leavened dough.

Advantageously, the dough raised and cut by the machine is ready to cook. In the state of the art for a long time it was important not to increase the amounts of water beyond 60% to not have dough difficult to knead, cut and distribute in bins.

The Applicant has found that the difficulties are mainly related to kneading the hand and the elasticity of the dough. Treatment with the machine according to the invention overcomes these difficulties because the blade 5 and the conveyor bands are particularly suitable for treating the dough.

The preferred composition and the ones according to the prior art differ in the water content in the preparation of the dough, however, there is a strong difference of reception taste on the bread obtained, that resulting from the dough according to the invention is much better after the specialists of the field.

More generally, the invention relates to a treatment process, in particular for dough.

The process preferably begins with a step of arranging the cutting conveyor 3 at least partially above the conveyor of the conveyor.

The process preferably begins with a step of arranging the cutting conveyor 3 at least partially above the receiving conveyor 7.

The process further comprises a step of forming a longitudinal cutting band of a cutting conveyor 3.

The process further comprises a step of driving a blade 5 in a cutting motion in a cutting direction 6 non-parallel to the cutting band so as to come into contact with the cutting band.

The process further comprises a step of driving the blade 5 and/or the separating translation cutting conveyor so that the blade is translated relative to and along the cutting band while remaining substantially in contact with the cutting band. The process further comprises a step of driving the cutting conveyor 3, via the blade 5 in cutting motion:
from an entry position in which the cutting conveyor 3 extends longitudinally according to an entry direction which is not parallel to the cutting direction, towards
a transfer position in which the cutting conveyor 3 extends in a transfer direction different from the direction of entry, and the cutting band comes into contact with the receiving band.

The process further comprises a step of driving the blade and/or the cutting conveyor 3 in a transfer translation so that the blade 5 is translated relative to and along the cutting band 4 at one end thereof while remaining substantially in contact with said end, then the blade 5 comes into contact with the receiving band.

1. A processing machine for dough, the machine comprising
a cutting conveyor (3) comprising a longitudinal cutting band,
a blade (5) configured to be driven in a cutting movement according to a cutting direction (6) that is on-parallel to the cutting band so as to come into contact with the cutting band,
the blade (5) and/or the cutting conveyor are further configured to be driven in a separating translation so that the blade (5) translates relative to and along the cutting band while remaining substantially in contact with the cutting band (4),
a receiving conveyor (7) comprising a longitudinal receiving band (8),
the cutting conveyor (3) being able to be arranged at least partially above the receiving conveyor (7),
and wherein the cutting conveyor (3) is movable between
an entry position in which the cutting conveyor (3) extends longitudinally in an entry direction not parallel to the cutting direction, and
a transfer position in which the cutting conveyor (3) extends in a direction of transfer different from the direction of entry, and the cutting band comes into contact with the receiving band (8),
the cutting conveyor (3) being configured to be driven by the cutting blade (5) from the entry position to the transfer position,
the blade and/or the cutting conveyor (3) being further configured to be driven in transfer translation so that the blade (5) translates relative to and along the cutting band (4) at one end of that while remaining substantially in contact with said end, then the blade (5) comes into contact with the receiving band (8).

2. The processing machine according to claim 1, wherein the blade is driven in the separating translation, and the conveyor is driven in the transfer translation.

3. The processing machine according to claim 1, wherein the cutting conveyor (3) is further movable from a rest position in which the cutting conveyor (3) is away from the blade (5), towards the entry position.

4. The processing machine according to one of the preceding claims, wherein the cutting conveyor (3) is rotatable between the entry position and the transfer position.

5. The processing machine according to claim lone of the preceding claims, wherein the blade (5) is further configured to be driven in translation in a slicing direction perpendicular to the separating translation.

6. The processing machine according to claim 1, further comprising a cooking device (9) associated with the receiving conveyor.

7. The processing machine according to the preceding claim 7, wherein the receiving conveyor (7) is disposed between the cutting conveyor (3) and the cooking device.

8. The processing machine according to claim 1, wherein at least one working surface comprises a non-stick coating.

9. The processing machine according to the preceding claim, wherein the cutting conveyor (3) has a triangular type section in the conveying direction.

10. (canceled)

11. The processing machine according to claim 3, wherein the cutting conveyor (3) is further movable from the transfer position to the rest position.

12. The processing machine according to claim 8, wherein at least the working surface comprising the non-stick coating is the receiving band (8).

13. A process for treating dough comprising more than 80% by weight of water relative to the weight of flour of the dough, the process comprising step for
driving a longitudinal cutting band of a cutting conveyor,
driving a blade in a cutting motion in a cutting direction not parallel to the cutting band so as to come into contact with the cutting band,
driving the blade and/or the cutting conveyor in a separating translation such that the blade translates relatively to and along the cutting band while remaining substantially in contact with the cutting band,
driving the cutting conveyor, through the blade in cutting motion,
from an entry position in which the cutting conveyor extends longitudinally in an entry direction which is not parallel to the cutting direction, towards
a transfer position in which the cutting conveyor extends in a direction transfer direction different from the direction of entry, and the cutting band comes into contact with the receiving band,
driving the blade and/or the cutting conveyor in transfer translation so that the blade translates relatively to and along the cutting band at one end thereof while remaining substantially in contact with said end, and then the blade comes into contact with the receiving band.

14. The process according to claim 13 comprising,
after the step for driving the blade and/or the cutting conveyor in a separating translation such that the blade translates relatively to and along the cutting band while remaining substantially in contact with the cutting band,
a step for arranging the cutting conveyor at least partially above the receiving conveyor,
before the step for driving the cutting conveyor, through the blade in cutting motion.
